(19) United States
(12) Patent Application Publication
(10) Pub. No.: US 2005/0263459 A1
(43) Pub. Date: Dec. 1, 2005

(54) Flow-through fluidized filter for water treatment

(76) Inventor: Roy Bowers, Verdi, NV (US)

Correspondence Address: KLARQUIST SPARKMAN, LLP, 121 SW SALMON STREET, SUITE 1600, PORTLAND, OR, 97204, US

(21) Appl. No.: 11/197,858

(22) Filed: Aug. 5, 2005

Related U.S. Application Data
(63) Continuation-in-part of application No. 10/669,874, filed on Sep. 23, 2003, now abandoned.

(51) Int. Cl. C02F 1/28

(52) U.S. Cl. 210/681; 210/284

(57) ABSTRACT

Certain embodiments provide a water quality improving filtration system. The filtration system includes a water filter having a water impermeable barrier. The water impermeable barrier defines a pooling volume. An inlet is in fluid communication with the water impermeable barrier and conducts water to the pooling volume. The pooling volume includes a quantity of fluidizable filtering media which includes a bimetallic substance. The water filter includes a block of adsorption material that is located in the interior of the water filter, as compared to the pooling volume. The block of adsorption material defines a cavity. A water outlet is in fluid communication with the cavity and conducts water from the water filter. The water impermeable barrier, pooling volume, and fluidizable filtering media cooperate to form a fluidized bed of filtering media.

### CROSS REFERENCE TO RELATED APPLICATION

This application is a continuation-in-part of, and expressly incorporates by reference in its entirety, U.S. patent application Ser. No. 10/669,874, filed Sep. 23, 2003.

### TECHNICAL FIELD

The present disclosure relates to methods and apparatus for purifying water. In particular embodiments, the present disclosure provides apparatus and methods for purifying water using a filter having a fluidized bed of solid filter media which includes a bimetallic substance.

### BACKGROUND

A large quantity of potable water is contaminated with a host of unwanted chemicals, minerals, and metals that are dissolved in, or carried by, the water. For example, much of the drinking water in the United States comes from wells or through old metal pipes. In other cases, objectionable ingredients are added by the water company. Other objectionable ingredients include byproducts of the disinfection process, including disinfection byproducts resulting from chlorine disinfection. For example, chlorine disinfection can produce trihalomethanes and choramines.

Water with such objectionable ingredients may taste odd to people when they drink it. In addition, the water can have deleterious health effects, such as having microbes, which may cause disease. A related problem is maintaining clear, sanitary, and odor free water in hot tubs, spas, and whirlpool baths of various sorts, hereinafter generically referred to as hot tubs.

There have been numerous attempts to maintain water quality. One common method involves adding large amounts of chlorine to the water. This method tends to impart a distinct chlorine odor, an odor so bad that it can, at times, be strong enough to cause mild respiratory distress. Moreover, in the case of hot tubs and similar environments which may require multiple additions of chlorine, the amount of chlorine in the water after frequent additions tends to become so concentrated that periodically all of the water in the hot tub must be replaced.

Other methods of maintaining water quality involve pumping large amounts of water through beds of chemicals that perform various purification steps to purify the water, primarily, various types of filtration, to the water. In hot tubs, these methods typically involve pumping water through piping that must be built in the water circulating system of the hot tub and place additional burdens on the pumping system of the hot tub.

One method of maintaining water quality is passing the water through a stationary bed of a bimetallic alloy that participates in oxidation/reduction reactions as the water passes through. If a bed is to work, large amounts of the alloy must typically be used to purify the water, and the alloy must typically be periodically cleaned by passing the water upstream through the bed, sometimes referred to as “backwashing.”

Many prior filtration methods use a series of separate filters, typically each in a separate sump, to perform various purification steps. For example, one sump may remove organic contaminants, another may remove chlorine, and yet another may remove lead. Although there are numerous examples of such filter systems on the market, examples of multicartridge filter systems include the POE-3 and POE-4 models, available from Enprotec, Inc., of Verdi, Nev.

Although capable of performing multiple purification processes, such filter systems can create a number of problems. For example, they may be heavy, bulky, inconvenient to store and transport, and expensive to manufacture. When multiple cartridges or sumps are used, the design of the filter systems may preclude their use in certain environments, such as environments with a relatively small space for a filter, environments requiring a standard filter size and structure, and environments requiring a single filter cartridge.

Although single cartridge, or sump, filters are known, they typically suffer from disadvantages. For example, The Brita Products Company of Oakland, Calif., and The Procter & Gamble Company (under its P\overline{U}R brand) of Cincinnati, Ohio, sell point-of-use systems, such as water filtration pitchers and water faucet attachments; The relatively slow flow rates of many such filters, including many filters capable of performing multiple purification processes, may preclude their use in point-of-entry systems.

Other filters, such as those available from LifeSource Water Systems, Inc., of Pasadena, Calif., and the HOMELAND SECURITY WATER FILTER (“HSWF”), available from Harnsco, Inc. of North Palm Beach, Fla., purport to provide multiple purification processes in a single filter unit at flow rates high enough for use in point-of-entry systems. However, the Lifesource filters must typically be periodically backwashed to maintain their purifying capabilities, which can waste water and, in any event, may not fully restore the purifying abilities of the filter.

The HSWF claims to use a single unit filter cartridge overlying a lower chamber where water is exposed to a UV light source. However, the HSWF can be expensive and inconvenient to purchase and maintain. For example, because the filter cartridge is a single unit, the entire filter cartridge must typically be replaced, even if only a single element needs to be cleaned or replaced. The UV lights require constant power and provide an additional part that may break or require service. In addition, the increased complexity of this filter may render it less user-serviceable, potentially requiring expensive technician service calls.

### SUMMARY

In certain embodiments, the present disclosure provides a fluid filtration system that includes a fluid filter. In particularly preferred embodiments, the fluid is water. The water filter has a water impermeable barrier that defines a pooling volume. An inlet conducts water to the pooling volume. A quantity of fluidizable filtering media, for example, fluidizable filtering media which includes a bimetallic substance, is disposed in the pooling volume. The water filter also contains an interiorly (compared to the pooling volume) located block of adsorption material. The block of adsorption material is in downstream fluid communication with the pooling volume. In particular embodiments, the block of adsorption material includes a block of carbon, which can include a zeolite, including a zeolite having an antimicrobial substance. A water outlet is in fluid communication with a cavity formed by the block of adsorption material and conducts water from the water filter. When the filtration system is in use, the water impermeable barrier, pooling volume, and fluidizable filtering media cooperate to form a fluidized bed of filtering media. In certain embodiments, a fluidized bed of filtering media may provide a number of benefits, such as potentially extending the lifespan of the fluidizable filtering media, keeping the filter media cleaner, increasing the operating time of the filter media, or conserving water, such as by eliminating the need to backwash the filter.

Particular embodiments may include additional filtering or purifying elements. For example, certain embodiments include a component to descale water passing through the water filtration system. For example, a descaling unit, such as a descaling unit that produces an electromagnetic field, may be located upstream from the pooling volume. In another example, a descaling media can be disposed in the pooling volume, such as by floating on the fluidizable filtering media.

Some disclosed embodiments of the filtration system have a filter that includes a fibrous filter. For example, a depth filter, such as a one micron absolute depth filter, may be included in the filter. In certain implementations, the fibrous filter may be disposed intermediate the pooling volume and the block of adsorption material. In further implementations, the fibrous filter may be disposed upstream from the fluidizable filtering media. For example, the fibrous filter may form an outer surface of the filter. If desired, the fibrous filter may be used with a descaling element, as previously described.

At least certain of the disclosed filtration systems may provide advantages by combining multiple filtration and purification processes in a single filter unit or housing. The ability of a single filter to perform multiple purification steps can allow for additional purification steps to be carried out on devices that were designed to perform fewer or different purification steps. Because fewer filter components may be needed if certain disclosed filtration systems are used, the disclosed filters may be manufactured in standard sizes. For example, in whole-house point-of-entry systems, the filters may be about 4 to about 16 inches in diameter and about 20, 30, or 40 inches long. For hot tub applications, the filters may be about 2-10 inches in diameter and about 4-40 inches long. However, the filter may be dimensioned as appropriate for any particular application. Accordingly, certain of the disclosed filtration systems may be easier to replace and maintain than filtration systems having multiple filter components or which are of non-standard size. Because of their ability to carry out multiple purification steps in a single unit, the disclosed filtration systems may be constructed in smaller sizes and thus take up less storage space and be less costly to transport. Because of their space-efficient design, the disclosed filtration systems can be more economical to manufacture and more lightweight than filtration systems using multiple filter components.

The present disclosure also provides methods for purifying water. For example, in one embodiment, water is passed through a portal in a filter device. From the portal, the water is passed through a pooling volume that includes a fluidized bed of fluidizable filtering media which includes a bimetallic substance. The water is also passed through a block of adsorption material. Compared to the pooling volume, the block of adsorption material is disposed towards the interior of the filter. The purified water is conducted from the filter device.

The methods can include additional steps. For example, the methods may include passing the water through a descaling unit prior to passing the water through the pooling volume. This method may involve, for example, subjecting the water to an electromagnetic field. In further embodiments, water may be passed through a descaling media that at least substantially floats on top of the fluidizable filtering media.

Subjecting the water to a descaling step may provide a number of benefits. For example, descaling may reduce the chance of filter components becoming clogged and reduce scale formation on downstream pipes. Descaling also typically reduces the surface tension of the water, which can increase the efficiency of downstream purification treatments.

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. Any particular embodiment need not provide all features noted above, nor solve all problems or address all issues in the prior art noted above or elsewhere in this specification.

### BRIEF DESCRIPTION OF THE DRAWINGS

Various embodiments are shown and described in connection with the following drawings in which:

FIG. 1A shows a front elevational cutaway view of a disclosed filter having an outer surface that includes a fibrous filter.

FIG. 1B shows a front elevational cutaway view of a filter having a rigid outer support covered by a removable filter sheath.

FIG. 2 is a front elevational cutaway view of a disclosed filter having an inlet port.

FIG. 3 is a front elevational cutaway view of the filter shown in FIG. 2 with a descaling unit upstream from the filter.

FIG. 4A is a front elevational cutaway view of the filter shown in FIG. 2 illustrating descaling media within the filter.

FIG. 4B is a front elevational cutaway view of a particular embodiment of the filter of FIG. 4A.

### DETAILED DESCRIPTION

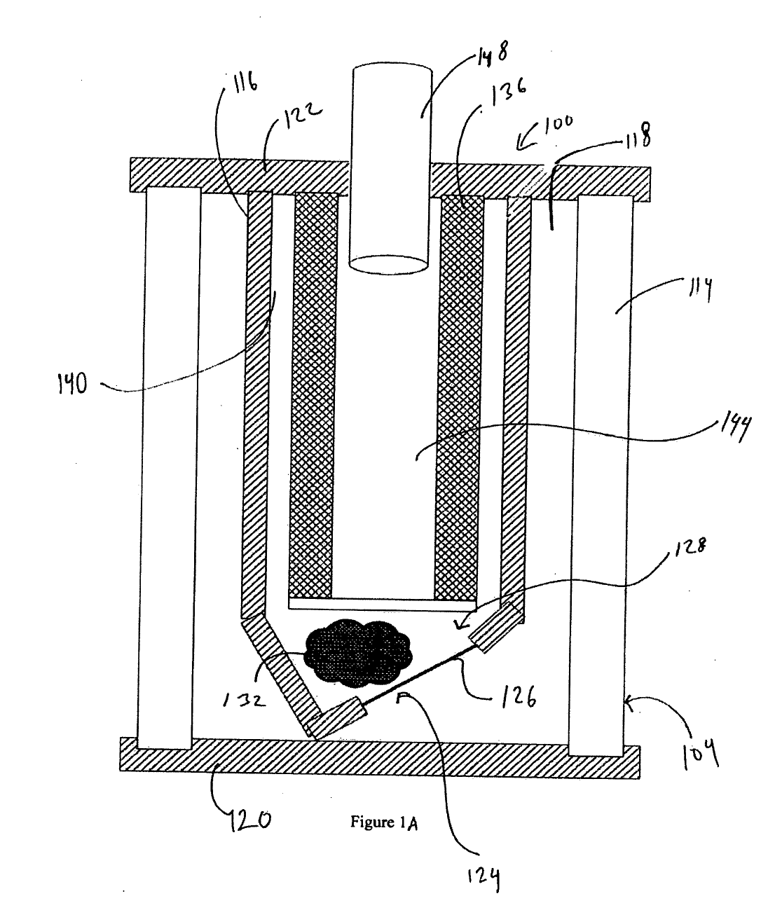

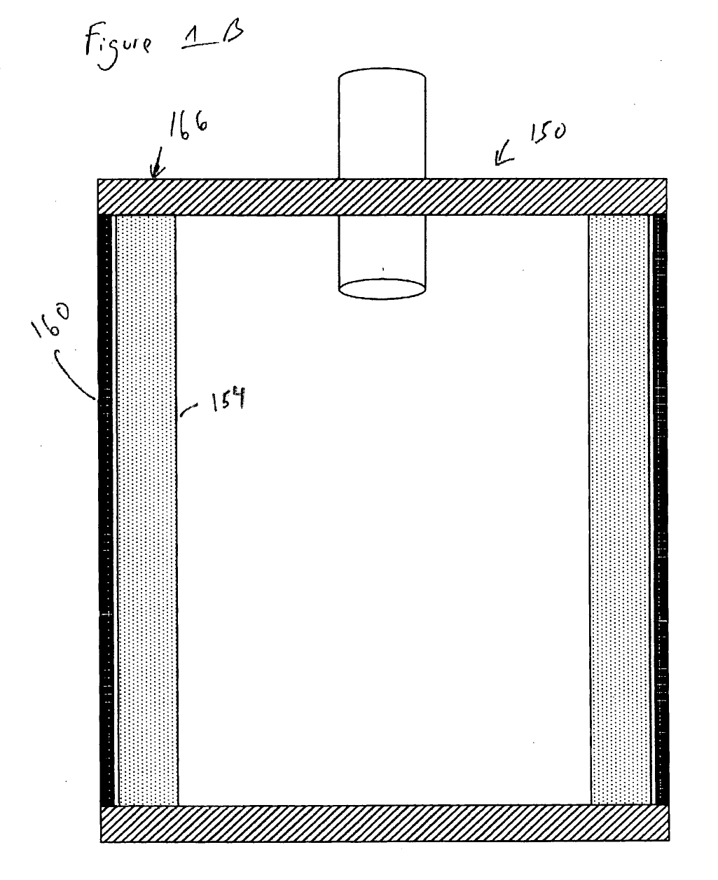

Referring to FIG. 1A, a filtration apparatus 100 has a substantially cylindrical outer structure 104 (which is shown in cross-section in FIG. 1A). The outer structure 104 is formed, in part, by a cylindrical, external, substantially supported rigid coarse filter 114. The rigid filter 114 may be made from various materials, such as non-woven fiber, such as paper. The rigid filter 114 may also be made from materials such as plastic fibers or foam rubber disposed in a mat or similar type structure. The exterior of the rigid filter 114 may be smooth (flat) as shown, or it may be folded (pleated) to increase the external surface area of the rigid filter 114. The rigid filter 114 may have enough structural strength to support itself, or it may be supported by an interior wall (not shown) that is water permeable.

Disposed centrally within the rigid filter 114 is a generally cylindrical inner tube 116 which tapers towards the bottom of the outer structure 104. The inner tube 116 has a diameter less than that of the rigid filter 114 and the gap between the two defines a generally cylindrical annulus 118, which expands slightly towards the bottom of the outer structure 104, about the conical portion of the inner tube 116. The inner tube 116 is water impermeable.

A generally disc-shaped first end cap 120 is located adjacent the lower portion of the rigid filter 114. The first end cap 120 may be made from any suitable material that is at least substantially impermeable to fluids passing through the filtration apparatus 100. For example, when the fluid being filtered is water, the first end cap 120 may be made from plastic, glass, ceramics, woods, or metals. In certain embodiments, the rigid filter 114 may be received by the first end cap 120 in order to help support the rigid filter 114. For example, an indention (not shown) may be formed in the first end cap 120 and the rigid filter 114 may be placed in the indention.

A generally disc-shaped second end cap 122 is located adjacent the upper portion of the rigid filter 114. The second end cap 122 may be constructed similarly to the first end cap 120. The second end cap 122 may receive or support the rigid filter 114 in a similar manner to the first end cap 120. In at least certain embodiments, the second end cap 122 and the inner tube 116 are integrally formed.

At least one portal 124 is formed in a portion of the conical section of the lower portion of the inner tube 116. The portal 124 may be any suitable shape, such as arcuate or quadrilateral. The portal 124 is covered by an analogously shaped fluid permeable member 126. When the fluid being filtered is water, the fluid permeable member 126 may be a screening material, such as one made of metal, plastic, fabric, both woven and non-woven, and the like. The permeable membrane 126 may be made from material normally used in the top of purification units. In at least certain embodiments, the permeable membrane 126 has openings sufficiently small to prevent particles larger than about 250 μm from passing through. Additional portals, such as two, three, four, or more portals could be included if desired. Although shown at the bottom of the filtration apparatus 100, the portals could be formed in other locations, such as the top or sides of the filtration apparatus 100.

Above the fluid permeable membrane 126 is a pooling volume 128 containing a quantity of solid filtering material 132. As shown in FIG. 1A, the pooling volume 128 has a conical shape, with the tip pointing downward. However, the pooling volume 128 may be of any suitable shape and dimension, such as being cylindrical. In addition, the pooling volume 128 may be located elsewhere in the filtration apparatus 100, such as on the top or sides of the filtration apparatus. Suitable portals and screens may be included as needed to accommodate such alternate positions of the pooling volume 128.

The solid filtering material 132 is preferably loose so that it can easily mix with fluid to be filtered. The solid filtering material 132 may be of any suitable form, such as being granular, a powder, crystalline, embedded in nanospheres or microspheres, or in bead form. The solid filtering material 132 may be any suitable filtering agent, such as a bimetallic alloy.

Suitable bimetallic alloys include copper alloys, such as alloys with tin, silver, or magnesium. In particular embodiments, the alloy includes copper and zinc. In a particular, the bimetallic alloy is KDF 55, available from KDF Fluid Treatment, Inc., of Three Rivers, Mich.

The solid filtering material 132 typically is selected to interact with the components of the water and participate in a variety of oxidation-reduction reactions with various water components. The solid filtering material 132 may provide a number of benefits to the overall operation of water filtration apparatus 100. For example, the solid filtering material 132 may be selected to remove free chlorine from the water by reducing it to the chloride ion, which is typically unobjectionable in solution when the product water is to be used for consumption or for use in a hot tub, and which may bind the chloride to the metal alloy particles. The solid filtering material 132 may also be selected to react with oxygen in the water and with iron ions to precipitate ferric hydroxide and aid in inhibiting the growth and proliferation of iron metabolizing bacteria.

A cylindrical quantity of adsorption material 136 is centrally located in the pooling volume 128 and is coaxial with the outer structure 104. In one embodiment, the adsorption material 136 is hollow, cylindrical, compacted block of adsorption material 136, such as a carbon block, having a diameter less than the inner diameter of the inner tube. Suitable carbon blocks are compacted powdered activated carbon blocks, such as those sold by Calgon Carbon Corp., of Pittsburgh, Pa., under the trade name “Centaur powdered activated carbon.”

The adsorption material 136 may be selected to adsorb organic components in the water, including disinfection byproducts such as chloramines and trihalomethanes. When the filter apparatus 100 is used in a hot tub, organic constituents of the water can include oils washed off the body, degradation products of cells, suntan lotion, and other objectionable fluids and dissolved solids. The adsorption material 136 may also be selected to clarify and decolorize the water.

The adsorption material 136 may contain additional materials. For example, it may contain a zeolite. The zeolite may be selected from naturally occurring zeolites, such as, chabatite, mordenite, erionite, faujasite, and clinoptilolite, and synthetic zeolites such as ZSM-5. In a particular example, the zeolite is clinoptilolite. The zeolite can be selected to accomplish various purification steps, such as to remove ammonia from the water.

The adsorption material 136 may also be used to help prevent the formation of fine particles that might otherwise find their way into the final filtered product fluid. In at least certain embodiments, the filtration and treatment qualities of the adsorption material 136 provide enhanced filtration or treatment compared to systems lacking adsorption material 136.

If desired, the adsorption material 136 can be chosen to provide additional fluid treatments. For example, in certain embodiments, an antimicrobial material (not shown) is incorporated into adsorption material 136. Any suitable antimicrobial agent may be used. For example, when impurity treatment media 136 includes a zeolite, the zeolite may be treated with an antimicrobial material, such as one including silver ions, including antimicrobial materials available from AgION Technologies, Inc., of Wakefield, Mass.

A cylindrical second annular volume 140, coaxial with the outer structure 104, is defined by the area between the inside surface of the inner tube 116 and the adsorption material 136. The second annular volume lies above the pooling volume 128. The second annular volume 140 provides an area where fluidized solid filtering material 132 can freely rise and mix with the fluid being filtered.

The inside of the adsorption treatment media 136 defines a cylindrical cavity 144, coaxial with the outer structure 104. The cavity 144 is in communication with a tubular exit portal 148 which allows fluid to exit the filtration apparatus 100. The exit portal 148 can be defined in any suitable location of the filtration apparatus 100, such as the first end cap 120 or the second end cap 122. If the exit portal 148 is formed in the second end cap 122, as shown in FIG. 1A, fluid flows out of the top of the filtration apparatus 100. If the exit portal 148 is in the first end cap 120, a tube (not shown) is typically provided through the pooling volume 128 to the exit portal. The exit portal 148 need not be tubular, and could be, for example, an aperture formed in the first end cap 120 or the second end cap 122.

In one method of operation, fluid to be filtered by the filtration apparatus I 00 passes through the rigid filter 114 and flows downwardly toward the first end cap 120. The fluid flows upward through the fluid permeable membrane 126 covering the portal 124. The fluid enters the pooling volume 128 and mixes with the solid filtering material 132. The mixture of solid filtering material 132 and fluid rises into the second annular volume 140.

The upward flow of the water through the solid filtering material 132 preferably has sufficient force to lift at least some of the solid filtering material 132, but not so much force as to cause violent surging of the solid filtering material 132. Proper selection of flow rate helps to prevent the solid filtering material 132 from clumping together as it starts to react with constituents of the fluid flowing upward past the fluidized bed of solid filtering material 132. If the fluid flow is too high, the effectiveness of the fluid treatment may be reduced, but such high flow rates may be required in some applications such as in a hot tub. In such cases, more effective purification may occur when a hot tub, or other device, is in a slow filtration mode; such as when the hot tub is not occupied.

Fluid then passes through adsorption material 136, with impurities and dissolved material being adsorbed by the adsorption material 136, into the cavity 144. From the cavity 144, the fluid is conducted upwards through the exit portal 148 and out of the filtration apparatus 100.

In an alternative embodiment, the rigid filter 114 is replaced by the structure shown in FIG. 1B. FIG. 1B illustrates a generally cylindrical filter apparatus 150. The filter apparatus 150 has an outer rigid structure 154 having a number of apertures. For example, the outer rigid structure 154 may be made of plastic and have a number of perforations or openings formed therein, such as the plastic housings used in conventional pleated hot tub water filters. The number and size of the openings are chosen to provide a suitable flow rate for fluid passing into the filter apparatus 150. In further examples, the rigid outer structure 154 is a screening material, such as a wire mesh.

A water permeable sheath 160 is placed over the outside of the rigid structure 154. The water permeable sheath 160 acts a particulate filter and may be made from any suitable material, including fibrous materials, plastics, or sintered glass. For example, the water permeable sheath 160 may be made from foam rubber having a porosity of from less than one micron to about 30 microns, such as from about 1 micron to about 20 microns. The water permeable sheath 160 may be a one-piece molded component or may be formed from a sheet of material formed into a generally tubular shape by coupling opposing ends of the sheet. Suitable foam materials are available from New Dimension Industries of Moonachie, N.J.

In certain embodiments, the water permeable sheath 160 is removable from the filter apparatus 150. A removable sheath 160 may provide a number of benefits. For example, if the filtering ability of the sheath 160 is reduced or eliminated, such as the pores of the sheath 160 becoming clogged, the sheath 160 could be removed and replaced, such as by the end user. The filter apparatus 150 may thus be rejuvenated without the need to replace the entire filter apparatus 150. This feature can make filters less expensive to replace and maintain. In addition, differing filtering capabilities could be achieved by changing the sheath 160, potentially allowing the filter apparatus 150 to take advantage of improved filtering technology or be adapted to new or different uses. In addition to being useable with the filters disclosed herein, the structure shown in FIG. 1B could be used with a variety of existing and later developed filters. For example, the filter 150 could, by itself, be designed to be used in hot tub type environments (which typically use fibrous filters, such as pleated paper filters).

The rigid structure 154 may be attached to the top or bottom of the filter apparatus 150. For example, the rigid structure 154 may be mounted to a removable upper end cap 166. When the sheath 160 is to be changed, the upper end cap 166 can be removed from the filter 150, the sheath 160 removed from the rigid structure 154, replaced with a new (or rejuvenated) sheath 160, and the upper end cap 166 reconnected to the filter 150.

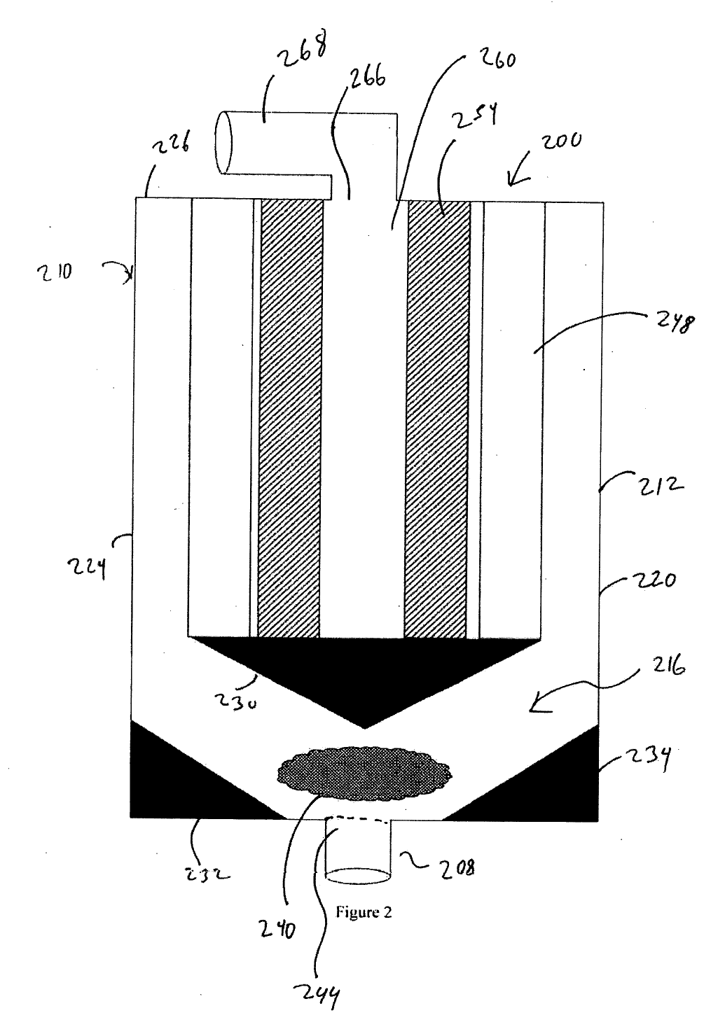

FIG. 2 illustrates an alternative embodiment, filtration system 200. The filtration system 200 includes a tubular inlet pipe 208 that transports a fluid to be treated into a filter apparatus 210. The inlet pipe 208 centrally intersects a lower portion 212 of the filter apparatus 210. The filter apparatus 210 is shown as generally cylindrical (a cross-section of which is shown in FIG. 2), but may be any suitable size and shape and formed from any suitable material. For example, the filter apparatus 210 may be conical, rectangular, or hexagonal. The filter apparatus 210 may be formed from materials such as metals and metal alloys, such as stainless steel, copper, brass, plastics, such as polypropylene or PVC, or a combination of materials.

The outlet end of inlet pipe 208 is in communication with a mixing volume 216. As shown, the mixing volume 216 is defined by the lower portion 212 of the filter apparatus 210, the vertically extending sides of the filter 220, 224, and the horizontal edge of the upper portion 226 of the filter apparatus 210. However, the mixing volume 216 could be located elsewhere in the filter apparatus 210, such as in the top or sides of the filter apparatus 210.

A conical upper baffle 230, axially aligned with the filter apparatus 210 and having a downward pointing tip, and left and right baffles 232, 234, each having a triangular cross-section, may be included in the mixing volume 216 to help direct the flow rate of fluid, control the turbulence of the fluid, and to direct the flow of the fluid. Although baffles 230, 232, 234 are shown as having a triangular cross-section, other shapes may be used, including squares, rectangles, arcs, circles, and ellipses, and the baffles may be placed in other locations to facilitate the flow of the liquid through the filter apparatus 210.

A quantity of solid filtering material 240 is located in the lower portion of the mixing volume 216. The solid filtering material 240 may be selected as described above. In at least certain embodiments, a screen 244 is placed over the junction between the inlet pipe 208 and the filter apparatus 210. The screen 244 is preferably chosen to prevent the solid filtering material 240 from leaving the filter apparatus 210 and may be selected as described for the fluid permeable membrane described above.

A cylindrical particulate filter 248 is central located within, and axially aligned with, the filter apparatus 210. Although the particulate filter 248 is shown centered in the upper portion 226 of the filter apparatus 210, the particulate filter 248 may be located in other positions. For example, the particulate filter 248 could be located on a side 220, 224 of the filter apparatus 210, with only one side in contact with fluid to be filtered. Rather than being located adjacent the top 226 of the filter apparatus 210, the particulate filter 248 could be located lower in the filtration apparatus 210.

The particulate filter 248 removes particulate matter from the water and may be any suitable water filter, for example, various types of paper or fibrous filters. For example, the particulate filter 248 may be a depth filter or a pleated filter. In at least certain embodiments, the particulate filter 248 is a one micron filter, such as a one micron absolute pleated filter. Suitable pleated filters are available from Harmsco, Inc., of North Palm Beach Florida. For example, part number PP BB-20-1 is suitable for use in the disclosed filter system 200. Suitable depth filters are available from Hantech Corp., of Santa Fe Springs, Calif.

An adsorption material 254 is located at least adjacent the particulate filter 248. For example, as shown in FIG. 2, the adsorption material 254 is centrally located within the particulate filter 248. The adsorption material 254 is generally cylindrical (shown in cross-section in FIG. 2) and axially aligned with the filter apparatus 210. The particulate filter 248 may be directly adjacent adsorption material 254, or there may be a gap therebetween. Adsorption material 254 may be selected as described above. Although the adsorption material 254 is shown at the center of the filter apparatus 210, it may be located elsewhere. In addition, although the adsorption material 254 is shown as being cylindrical, other shapes may be used.

The adsorption material 254 at least partially defines a generally cylindrical fluid volume 260 at the interior portion of the filter apparatus 210. As shown in FIG. 2, the fluid volume 260 is in communication with a circular exit port 266 formed in the center of the upper portion 226 of the filter apparatus 210. A tubular exit pipe_268 is shown coupled to the exit port 266. However, the present disclosure is not limited to the configuration shown in FIG. 2. For example, in certain embodiments, fluid from the fluid volume 260 may exit the filter apparatus 210 through the lower portion 212 or sides 220, 224 of the filter apparatus 210. In such embodiments, a pipe (not shown) may be provided to conduct fluid from the fluid volume 260.

In use, fluid passes upwardly into the filter apparatus 210 through the inlet pipe 208. The fluid enters the mixing volume 216 where it, guided by the baffles 230, 232, 234, mixes with the solid filtering material 240, thus removing chlorine or other contaminants from the water. The water then passes the particulate filter 248, which removes particulates from the water. The water then passes through adsorption material 254, removing organic contaminants or other materials from the water. The water then passes out of the filtration apparatus 210 through the exit port 266 and the exit pipe 268.

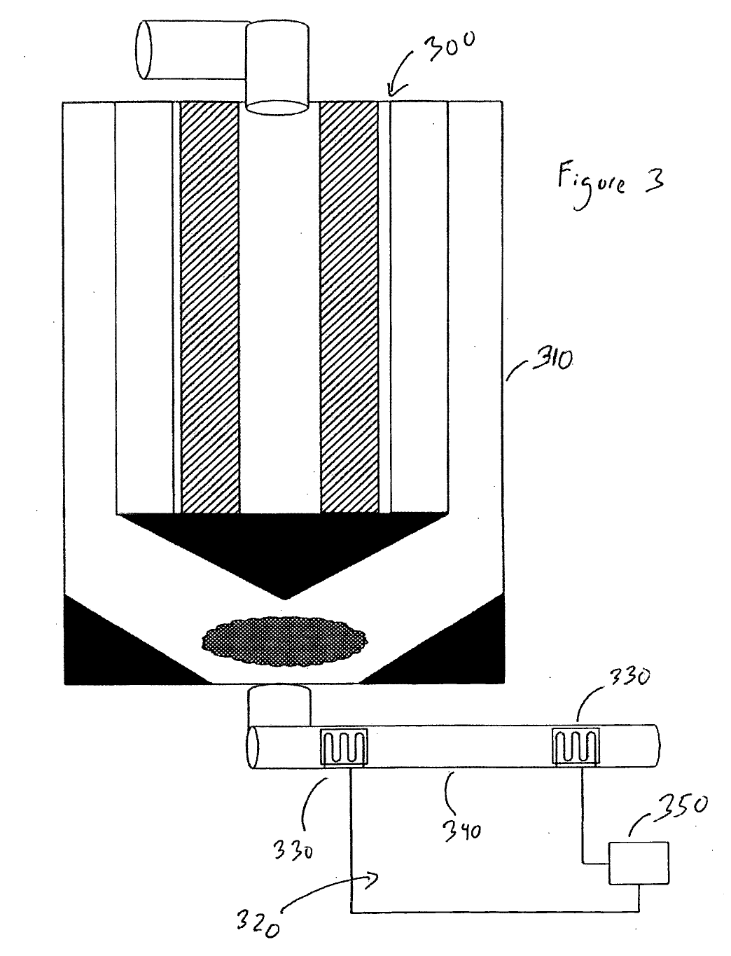

With reference now to filtration system 300 shown in FIG. 3, in certain embodiments, including the embodiments illustrated in FIGS. 1 and 2, the filtered fluid is passed through a descaling unit 320 before or after it passes through the filtration unit 310. For example, as shown in FIG. 3, the fluid passes through the descaling unit 320 before entering filtration the unit 310.

Suitable descaling units 320 include the AquaVantage unit, available from Vil Electronics of the United Kingdom or Enprotec, Inc., located in Verdi, Nev. However, any other suitable descaling unit may be used, including the Scalewatcher device, available from Scalewatcher North America, Inc., of Oxford, Pa.; the Scaleban device, available from EcoSoft Systems, Inc., of Phoenixville, Pa.; the Dolphin system, available from Clearwater Systems LLC of Essex, Conn.; and the Scaleblaster device, available from ClearWater Enviro Technologies, Inc., of Clearwater, Fla. Certain principles of electronic descaling are described in U.S. Pat. No. 5,074,998, which is hereby expressly incorporated by reference in its entirety. In at least certain embodiments, the descaling unit 320 operates by causing calcium and other ions to precipitate from solution, such as in the form of crystals, such as submicron crystals.

As shown in FIG. 3, the descaling unit 320 includes two wire segments 330 wound around a section of pipe 340. Each wire segment 330 may consist of a certain number of turns, such as 25 turns, of wire. The wires segments 330 are connected to power supply 350. When power is supplied by the power supply 350 to the wire segments 330, an electrical field is generated about the pipe 340, causing calcium and other mineral ions to precipitate from solution. Such systems may be advantageous because they do not directly contact the fluid.

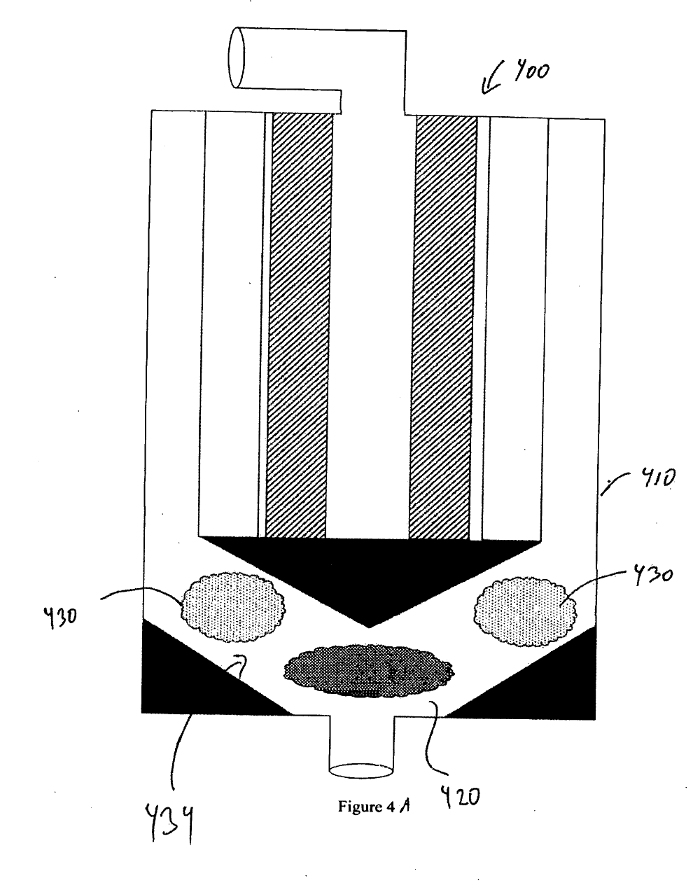

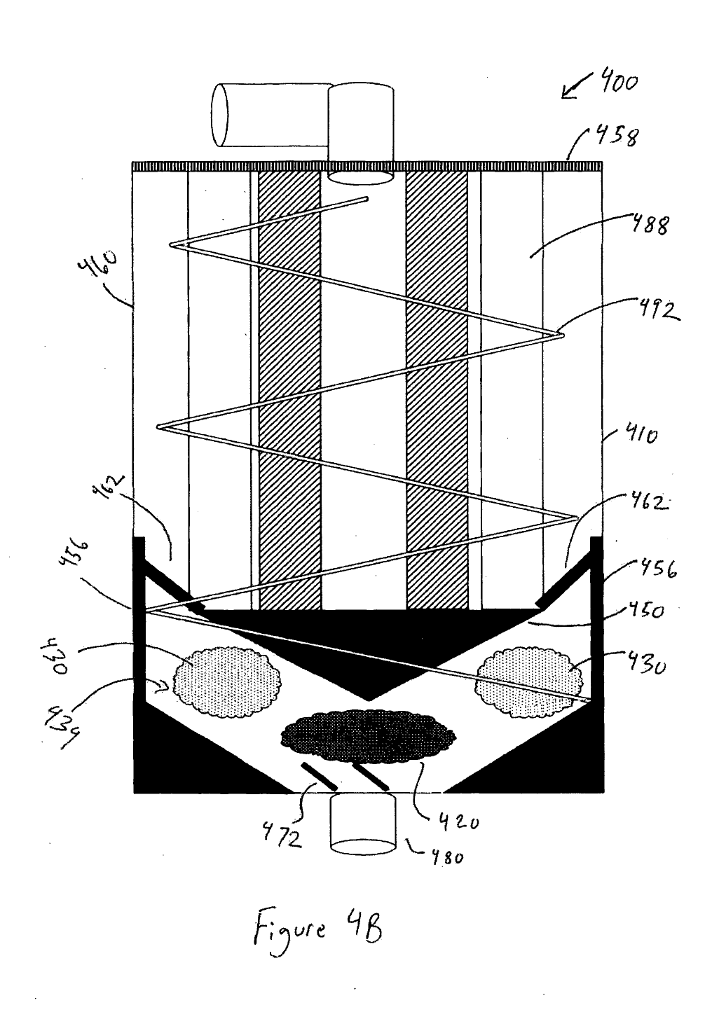

Descaling may be accomplished by other means. For example, FIG. 4A shows a filtration system 400 that is generally similar to the filtration system 200 of FIG. 2. However, in addition to the solid filtering material 420, the filter 410 includes a quantity of descaling media 430 located above the solid filtering material 420 in the mixing volume 434. In at least certain embodiments, the descaling media 430 is lighter than the solid filtering material 420 so that the descaling media 430 floats on top of the solid filtering material 420. However, the filter 410 may be constructed differently. For example the descaling media 430 could be separated from the solid filtering material 420, such as a by a baffle, portal, screen, or membrane. In addition, the descaling media 430 could be located elsewhere in the filter 410, such as upstream or downstream from the solid filter material 420.

The descaling media 430 may be any suitable media and may operate by any suitable method. In at least certain embodiments, the descaling media 430 causes calcium and other ions, such as mineral ions, in the fluid to form crystals, such as submicron crystals. In a particular example, the descaling media 430 is the Spectrasoft media from Melstream Industries, available from ZPT International, Inc., of Destin, Fla.

FIG. 4B illustrates a particular embodiment of the filter shown in FIG. 4A. A centrally located baffle 450 is supported by longitudinal vertically extending braces 456 proximate the sides 460 of the filter 410. The braces 456 may be connected to sides 460 of the filter 410 or to the lower baffles 466. The braces 456 provide support for the central baffle 450. Diagonally downwardly extending supports 462 are connect to the baffle 450 and the braces 456. The filter 410 includes a removable top end 458 to allow access to the interior of the filter 410 and removal of components therefrom. The removeable top end 458, the braces 456, and the supports 462 may allow for easier assembly and disassembly of the filtration system 400.

An inlet baffle 472 is centrally disclosed proximate the lower end of the filter 410 and is in fluid communication with a fluid inlet 480. The inlet baffle 472 directs incoming fluid toward the left side 460 of the filter 410. The inlet baffle 472 aids in agitating the incoming fluid with the descaling media 430 and the solid filtering material 420. The inlet baffle 472 also directs the mixture of fluid, solid filtering material 420, and descaling media 430 against the sides 460 of the filter 410 and may help prevent particles of the solid filtering material 420 and descaling media 430 from entering a particulate filter 488. The particulate filter 488 is centrally located in the interior of the filter 410 and is axially aligned with the filter 410.

A coil 492, such as a 0.25 inch diameter coil, may be placed inside the filter 410. The coil 492 serves to further agitate the incoming fluid and direct it against the sides 460 of the filter 410.

An advantage of at least certain embodiments of the disclosed filtration systems is that they allow for more compact system designs. For example, typical prior filter systems utilize a series of filter units to perform each purification step. For example, a fibrous filter might be connected in series to a solid filtering material, which in turn might be connected to an adsorption material. Designs according to the present disclosure may accomplish the same filtration steps in a single filter unit. For example, in at least certain embodiments where the filtration system is to be used for a residential point-of-entry system, a single sump is used that has a diameter from about 4 to about 16 inches. The filter units may be made in a number of lengths, such as to fit industry standard sizes, such as about 20, 30, or 40 inches. Accordingly, at least certain of the disclosed filtration systems may be more lightweight, easier to transport, more economical to manufacture, easier to change, capable of having higher flow rates, more effective at removing contaminants from filtered fluids, or more compact than prior filtration systems.

The disclosed filters and filter systems may be used in hot tubs and swimming pools as replacements for the filters and chemicals normally used in those hot tubs and swimming pools. Accordingly, the dimensions of the disclosed filtration systems may be customized to fit the various models and types of filter tubes. In contrast to typical current filters, which merely remove coarser particles from the water, the disclosed filtration systems perform additional purification steps. The disclosed filtration systems can be used to condition the water and allow one filtration unit, in a single housing, to substantially purify and condition the water without the addition of other chemicals or other further processing. In particular, the fluidized solid filtration material within the disclosed filtration units cleans and conditions the fluidized media found within the filtration unit, and automatically keeps the media in optimal condition for conditioning the water.

The disclosed filters may be used in closed systems, such as a hot tub or a swimming pool, where the water is filtered and returned back to the hot tub via a return pipe. A pump may propel the water through the circuit. The disclosed filters may also be used in open systems, such as in a domestic or commercial water softening or filtration applications, where the flow of water is pushed by local water pressure.

The pH of the water used to be processed using the disclosed filters is typically between about five and nine, preferably between about 6.5 and 8.5, and most preferably between about 7.2 and 7.8. The pH of the water can be adjusted by conventional means, such as by the addition of hydrochloric or muriatic acid (HCl) and sodium bicarbonate (Na₂CO₃). In at least some embodiments, the water to be filtered has a relatively small amount of calcium dissolved therein; preferably the water will contain no more than between about zero to three hundred parts per million (ppm), preferably between about zero to two hundred ppm, and most preferably between about zero to one hundred fifty ppm calcium hardness. Descaling steps, such as those described above, can be used to reduce the calcium ion content of the water that exceeds these limits, up to about 340 to about 515 ppm.

When used in hot tub type applications, the disclosed filters may reduce or eliminate the need to empty the water in the hot tub, at least if the level of total dissolved solids in the water is appropriately monitored and maintained.

It is to be understood that the above discussion provides a detailed description of various embodiments. The above descriptions will enable those skilled in the art to make many departures from the particular examples described above to provide apparatus constructed in accordance with the present invention. The embodiments are illustrative, and not intended to limit the scope of the present invention. The scope of the present invention is rather to be determined by the scope of the claims as issued and equivalents thereto.

1. A water quality improving water filtration system comprising a filter comprising:
(A) a water impermeable barrier, the water impermeable barrier defining a pooling volume;
(B) a water inlet in fluid communication with the water impermeable barrier, whereby the water inlet may conduct water to the pooling volume;
(C) a quantity of fluidizable filtering media comprising a bimetallic substance disposed in the pooling volume;
(D) a block of adsorption material located interiorally to the pooling volume and in downstream fluid communication with the pooling volume, the block of adsorption material defining a cavity; and
(E) a water outlet in fluid communication with the cavity, whereby the water outlet may conduct filtered water from the water filter;
whereby, when the water filtration device is in use, the water impermeable barrier, pooling volume, and fluidizable filtering media cooperate to form a fluidized bed of filtering media.

2. The water quality improving water filtration system of claim 1, wherein the filter comprises a single housing.

3. The water quality improving water filtration system of claim 1, wherein the bimetallic substance comprises a zinc and copper alloy.

4. The water quality improving filtration system of claim 1, wherein the bimetallic substance comprises KDF.

5. The water quality improving filtration system of claim 1, the filter further comprising a quantity of descaling media disposed in the pooling volume.

6. The water quality improving filtration system of claim 5, wherein the descaling media is located generally downstream from the fluidizable filtering media.

7. The water quality improving filtration system of claim 1, further comprising a descaling unit upstream from the pooling volume.

8. The water quality improving filtration system of claim 7, wherein the descaling unit comprising an electronic descaling unit producing an electromagnetic field.

9. The water quality improving filtration system of claim 1, wherein the block of adsorption material comprises a block of carbon.

10. The water quality improving filtration system of claim 9, wherein the block of adsorption material comprises a zeolite.

11. The water quality improving filtration system of claim 10, wherein the zeolite comprises an antimicrobial substance.

12. The water quality improving filtration system of claim 11, wherein the antimicrobial substance comprises silver ions.

13. The water quality improving filtration system of claim 1, the filter further comprising a particulate filter disposed intermediate the pooling volume and the block of adsorption material.

14. The water quality improving filtration system of claim 13, wherein the particulate filter comprises a pleated filter or a depth filter.

15. The water quality improving filtration system of claim 1, the filter further comprising a particulate filter disposed upstream from the fluidizable filtering media.

16. The water quality improving filtration system of claim 15, wherein the pooling volume is disposed within the particulate filter.

17. The water quality improving filtration system of claim 15, the filter further comprising a rigid outer structure defining a plurality of openings, the particulate filter being removably disposed on the rigid outer structure.

18. The water quality improving filtration system of claim 17, wherein the particulate filter is made from a porous plastic material.

19. A water quality improving water filtration system comprising a filter comprising:
(A) a water impermeable barrier, the water impermeable barrier defining a pooling volume;
(B) a water inlet in fluid communication with the water impermeable barrier, the water inlet conducting water to the pooling volume;
(C) a quantity of fluidizable filtering media comprising a zinc and copper alloy disposed in the pooling volume;
(D) a block of carbon comprising a zeolite located interiorally to the pooling volume and in downstream fluid communication with the pooling volume, the block of adsorption material defining a cavity;
(E) a particulate filter disposed intermediate the pooling volume and the block of carbon; and
(F) a water outlet in fluid communication with the cavity, the water outlet conducting filtered water from the water filter;
wherein, when the water filtration device is in use, the water impermeable barrier, pooling volume, and fluidizable filtering media cooperate to form a fluidized bed of filtering media.

20. An impurity removing water filtration method comprising:
(A) passing water through a portal in a filter device;
(B) passing water from the portal through a pooling volume in the filter device, the pooling volume comprising a fluidized bed of fluidizable filtering media comprising a bimetallic substance;
(C) passing water from the fluidized bed of fluidizable filtering media through a block of adsorption material disposed interiorally to the pooling volume; and
(D) passing water from the block of adsorption material outside the filter device.

21. The impurity removing water filtration method of claim 20, further comprising, prior to passing water through the pooling volume, passing the water through a descaling unit.

22. The impurity removing water filtration method of claim 21, wherein passing the water through a descaling unit comprises subjecting the water to an electromagnetic field.

23. The impurity removing water filtration method of claim 20, further comprising passing the water through a descaling media.

24. The impurity removing water filtration method of claim 23, wherein the descaling media at least substantially rides on top of the fluidizable filtering media.

25. The impurity removing water filtration method of claim 20, further comprising passing the water through a fibrous filter disposed in the filter device.

26. The impurity removing water filtration method of claim 20, wherein passing water through a portal in a filter device comprises passing the water through a fluid-permeable membrane.

27. The impurity removing water filtration method of 20, further comprising subjecting the water to a descaling treatment and, prior to passing the water through the block of adsorption material, passing the water through a particulate filter disposed in the filter device.
